(19) United States
(12) Patent Application Publication
(10) Pub. No.: US 2009/0195193 A1
(43) Pub. Date: Aug. 6, 2009

(54) COMPACT FLUORESCENT LIGHT DEVICE

(76) Inventor: Peter D. Joseph, Twin Lakes, WI (US)

Correspondence Address: BRINKS HOFER GILSON & LIONE, P.O. BOX 10395, CHICAGO, IL, 60610, US

(21) Appl. No.: 12/334,613

(22) Filed: Dec. 15, 2008

Related U.S. Application Data
(60) Provisional application No. 61/026,305, filed on Feb. 5, 2008.

(51) Int. Cl. H05B 37/00

(52) U.S. Cl. 315/326

(57) ABSTRACT

A light device, such as a device using compact fluorescent light, is disclosed. The light device includes a housing. A compact fluorescent light source is supported by the housing. A converting device is coupled with the compact fluorescent light source. The converting device is provided for connecting with a low voltage line.

### RELATED APPLICATION

This application claims priority under 35 U.S.C §119(e) to U.S. Provisional Patent Application No. 61/026,305 filed on Feb. 5, 2008, which is hereby incorporated by reference in its entirety.

### BACKGROUND

Lighting systems are used on a daily basis. Light emitting diodes (“LEDs”) and incandescent lights illuminate a variety of settings. For example, such lights are used to illuminate driveways, pathways, and other outdoor surroundings. However, incandescent light bulbs operate at a relatively low efficiency and high temperatures. LEDs may be more efficient, but they tend to produce a relatively low light output and are more expensive. There are less expensive light sources with better efficiency than incandescent light bulbs, but these light sources operate off of 110 alternating current volts (“VAC”). Operating such lights in an outdoor environment may present challenges because it may be difficult to connect with a 110 VAC source. Routing 110 VAC to outdoor locations may be difficult and costly.

### BRIEF SUMMARY

In one aspect, a light device is provided. The light device includes a housing. A compact fluorescent light source is supported by the housing. A converting device is coupled with the compact fluorescent light source. The converting device is provided for connecting with a low voltage line. The converting device converts an alternating current voltage provided by the low voltage line to substantially at least 90 alternating current volts RMS. The compact fluorescent light source is powered by the substantially at least 90 alternating current volts RMS.

Other systems, methods, features and advantages of the design will be, or will become, apparent to one with skill in the art upon examination of the following figures and detailed description. It is intended that all such additional systems, methods, features and advantages be included within this description.

### BRIEF DESCRIPTION OF THE DRAWINGS

The components in the figures are not necessarily to scale, emphasis instead being placed upon illustrating the principles of the design. Moreover, in the figures, like referenced numerals designate corresponding parts throughout the different views.

FIG. 1 is a perspective view of a low voltage system;

FIG. 2 is a block diagram illustrating components of a light device of the low voltage system of FIG. 1;

FIG. 3 is a circuit schematic of the light device FIG. 2;

FIG. 4 is an alternate circuit schematic of the light device of FIG. 2; and

FIG. 5 is a flowchart illustrating a method for providing light.

### DETAILED DESCRIPTION

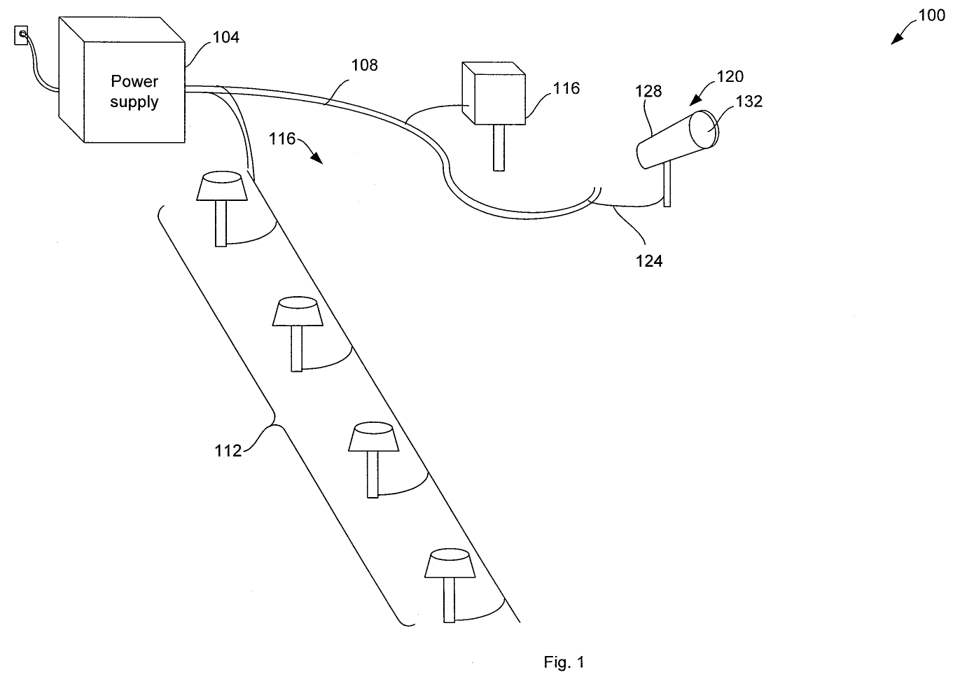

FIG. 1 is a perspective view of a low voltage system 100. The system 100 is an outdoor light system or other system that produces a low voltage to power and/or operate devices. For example, the system 100 is a low voltage outdoor lighting system. The system 100 includes, but is not limited to, a power supply 104, a power supply line 108, one or more remote devices 112, a remote device 116, and a compact fluorescent light device 120. Fewer, more, or different components or devices may be provided.

The power supply 104 is used to supply power to the remote devices via the power supply line 108. For example, the power supply 104 is a low voltage power supply that electrically connects with a standard wall outlet or other high voltage outlet that provides at least 90 alternating current volts (“VAC”) RMS or 110 VAC RMS. The power supply 104 converts the at least 90 VAC RMS or 110 VAC RMS to at most 15 VAC RMS, such as 12 VAC, to power the remote devices 112 and 116. The power supply 104 may include timers, photo sensors, and/or a switch to turn the power supply on or off. Also, the power supply 104 may generate an encoded signal to power and communicate with the remote devices 112 and 116, such as described in U.S. provisional application No. 61/026,282, filed on Feb. 5, 2008, and also U.S. patent application Ser. No. ______ filed on even date herewith, both of which are entitled “POWER LINE COMMUNICATION,” and are both hereby incorporated by reference.

The remote devices 112 may be lights. For example, the remote devices 112 are outdoor lights that may be placed in a driveway or pathway of a homeowner's yard or other property. The remote device 116 is a low power strip, fan, radio, light, or other device that is powered by a low voltage, such as 12 volts. The remote devices 112 and 116 may include a processor or other circuitry to operate (such as turning on or off or changing a brightness level) based on signals or data transmitted by the power supply 104. The remote devices 112 and 116 connect with the power supply line 108 using a connector. The connector has two pins that penetrate a cover of the power supply line 108 and electrically connect with internal conductors. Alternatively, other connectors may be used.

The compact fluorescent light device 120 also connects with the power supply line 108 via a connection 124. The connection 124 is a wire or cable that includes a connector. The connector has two pins that penetrate a cover of the power supply line 108 and electrically connect with internal conductors. Alternatively, other connectors may be used. The connection 124 supplies the low voltage, such as the 12 VAC, to the compact fluorescent light device 120.

A structure of the compact fluorescent light device 120 includes, but is not limited to, a housing 128 and a window or pass way 132 (hereinafter referred to as the pass way 132). Fewer, more, or different components may be provided. The housing 128 is made of conductive and/or non-conductive material. The housing 128 has a substantially cylindrical or conical. Alternatively, other geometrical shapes may be used. For example, the housing 128 has a shape or form factor of a flood light.

The housing 128 supports or allows for the pass way 132. The pass way 132 is a window made of glass, plastic, air, or other medium allowing light to pass through. The compact fluorescent light device 120 may act as an outdoor floodlight. Flood lights direct light over a large area. For example, flood lights may be used for security purposes and/or outdoor residential lighting. The compact fluorescent light device 120 may be mounted on a building, a support, or on the ground of an outdoor environment. The compact fluorescent light device 120 may be aimed to illuminate desired areas, such as outdoor areas.

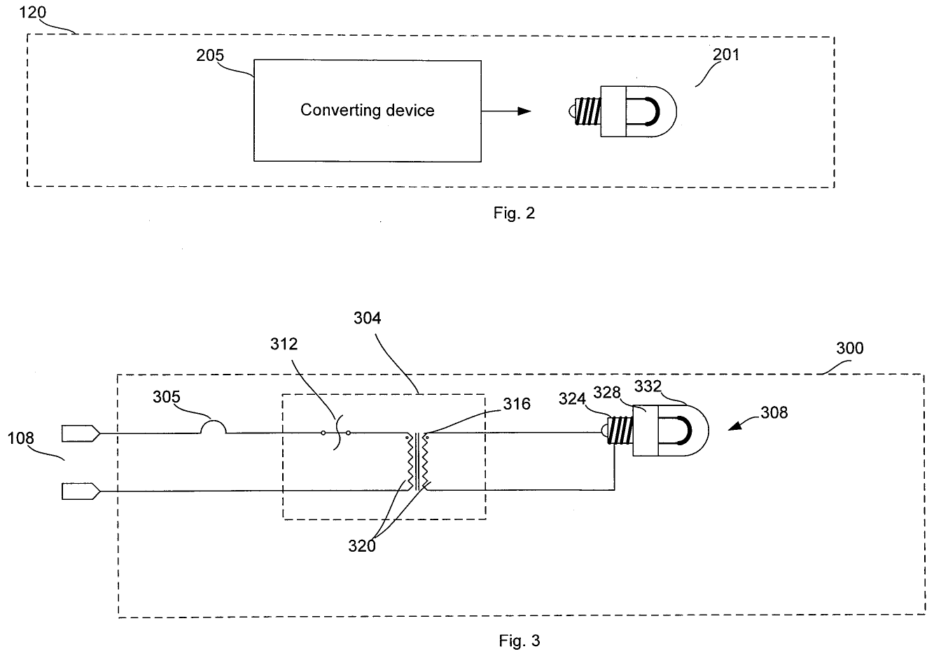

FIG. 2 is a block diagram illustrating components of the compact fluorescent light device 120. For example, the compact fluorescent light device 120 includes a compact fluorescent light source 201 and a converting device 205. Fewer, more, or different components may be provided. For example, the compact fluorescent light device 120 may include an electrical and/or mechanical switch, a circuit breaker, a processor, rectifier circuits, a fuse, passive components and/or other components.

The compact fluorescent light source 201 is a conventional compact fluorescent light source. For example, the compact fluorescent light source 201 is a standard compact fluorescent light bulb, lamp, and/or tube that may be purchased off-the-shelf. The compact fluorescent light source 201 has a spiral, semi-circular, circular, cylindrical, or other geometrical shape. Alternatively, the compact fluorescent light source 201 includes at least two or a plurality of standard compact fluorescent light bulbs. The compact fluorescent light source 201 operates on at least 90 VAC RMS or 110 VAC RMS.

The converting device 205 is a step-up transformer, an inverter circuit, or other device configured to convert a low voltage to a higher voltage, such as a higher alternating current voltage. For example, the converting device 205 receives a signal at an input. The signal is a low voltage alternating current, such as the 12 volts on the power supply line 108 provided by the power supply 104. The converting device 205 converts the signal to or uses the signal to generate a higher alternating current voltage, such as at least 90 VAC RMS or 110 VAC RMS. The higher voltage is provided to the compact fluorescent light source 201.

Alternatively, the signal provided by the power supply line 108 may be a low voltage direct current (“DC”) signal. Or, the signal provided by the power supply line 108 may be an alternating signal with a substantially square wave form instead of a sinusoidal form. The signal provided by the power supply line 108 may be encoded to communicate with circuitry or logic of the compact fluorescent light device 120.

The compact fluorescent light device 120 is moveable or transferrable. Therefore, instead of using an extension cable or routing 110 VAC from a house or other structure, the compact fluorescent light device 120 can connect to the existing low voltage power supply line 108 and illuminate the compact fluorescent light source 201 in a convenient and a pleasant aesthetic manner.

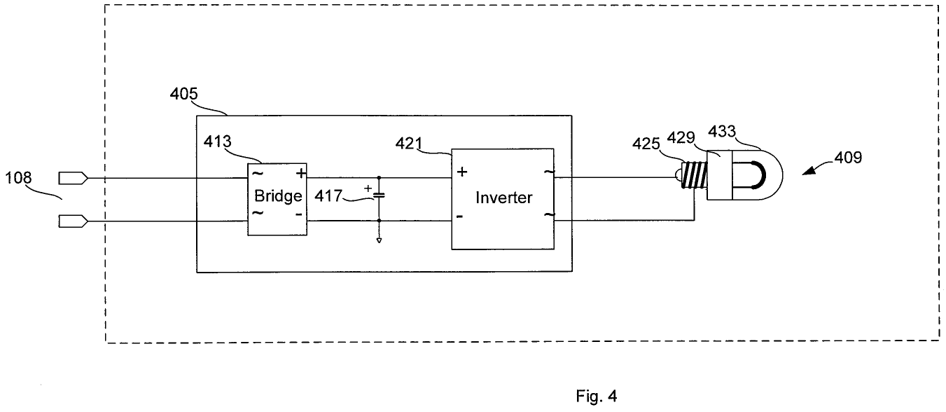

FIG. 3 is a circuit schematic of a compact fluorescent light device 300. The compact fluorescent light device 300 is similar to the compact fluorescent light device 120. The compact fluorescent light device 300 includes a transformer 304 and a compact fluorescent light source 308. Fewer, more, or different components may be provided.

The compact fluorescent light device 300 connects with the power supply line 108 via a connector, such as a connector that has two pins that penetrate a cover of the power supply line 108 and electrically connect with internal conductors, and/or another connector. The transformer 304 is coupled with the power supply line 108.

For example, the transformer 304 is a step-up transformer. The transformer 304 includes a thermal fuse 312, coils 320, and a core 316. The coils 320 are wrapped or twisted around the core 316 to generate magnetic flux in the core 316 and generate a higher output voltage. For example, the 12 VAC from the power supply line 108 is stepped up to about at least 90 VAC RMS or 110 VAC RMS at 60 HZ. The power supply line 108 may also be to provide voltages suitable for regions, such as Europe, that utilize substantially 220 VAC RMS at 50 HZ. The core 316 is an iron core, an air core, or other medium. The thermal fuse 312 is used as a safety feature. For example, if an overvoltage and/or over current occurs, the thermal fuse 312 breaks or disconnects the coils 320 from the power supply line 108. The disconnection may occur based on a temperature level or trigger of the thermal fuse 312. Alternatively, the transformer 304 does not include the thermal fuse 312. A current limiting device 305, such as a circuit breaker, fuse, or solid-state current limiter may be added to the circuit to provide additional protection.

The compact fluorescent light source 308 connects with the transformer 304. The compact fluorescent light source 308 is similar to the compact fluorescent light source 201. For example, the compact fluorescent light source 308 includes a connector 324, a power circuitry 328, and a bulb 332. Fewer, more, or different components may be provided.

The output of the transformer 304 couples with the connector 324. The connector 324 is a conductive material that is configured to receive voltage and/or current. For example, the connector 324 has a grooves or slots to attach to a light fixture. The connector 324 provides the at least 90 VAC RMS or 110 VAC RMS from the transformer 304 to the power circuitry 328. The power circuitry 308 includes passive and/or active components to appropriately apply the at least 90 VAC RMS or 110 VAC RMS to the bulb 332. Alternatively, the connector 324 may directly connect with the bulb 332.

The bulb 332 is a standard compact fluorescent light bulb, tube, or lamp. The bulb 332 may have a spiral, cylindrical, circular, semi-circular, or other geometrical shape. The bulb 332 is made of glass, plastic, or other medium that emits or allows light to pass through. The connector 324 and the power circuitry may be integral parts of the bulb 332 or may separate components.

FIG. 4 is a circuit schematic of a compact fluorescent light device 401. The compact fluorescent light device 401 is similar to the compact fluorescent light device 120. The compact fluorescent light device 401 includes a converting device 405, such as the converting device 205, and a compact fluorescent light source 409. Fewer, more, or different components may be provided.

The compact fluorescent light device 401 connects with the power supply line 108 via a connector, such as a connector that has two pins that penetrate a cover of the power supply line 108 and electrically connect with internal conductors and/or another connector. The converting device 405 connects with the power supply line 108 via the connector. The converting device 405 includes a bridge circuit 413, a capacitor 417, and an inverter 421. A current limiting device, such as a circuit breaker, fuse, or solid-state current limiter may be added to the circuit to provide additional protection. Fewer, more, or different components may be provided.

For example, the bridge circuit 413 is electrically connected with the power supply line 108. The bridge circuit 413 rectifies an alternating current voltage. For example, the bridge circuit 413 rectifies the 12 VAC on the power supply line 108. The bridge circuit 413 may include one or more diodes. Alternatively, other rectifier circuits may be used. The rectified signal is provided to the capacitor 417. The capacitor 417 has a capacitance value of about 4700 μF. Other capacitance values may be used. The capacitor 417 smoothens the rectified signal to provide a substantially DC signal.

The DC signal is provided to the inverter 421. The inverter 421 steps up or increases the DC level and converts the increased DC voltage to an alternating current voltage, such as at least 90 VAC RMS or 110 VAC RMS 60 HZ. Alternatively, the inverter 421 may step up or increase the DC voltage to an alternating current voltage suitable for regions, such as Europe, that utilize substantially 220 VAC RMS at 50 Hz. The inverter 421 includes a linear regulator or other device to increase the DC voltage as well as one or more switches, such as transistors, or other components to generate an AC voltage from the increased DC voltage. The output AC signal is provided to the compact fluorescent light source 409.

The compact fluorescent light source 409 is similar to the compact fluorescent light source 308 or 201. For example, the compact fluorescent light source 409 includes a connector 425, power circuitry 429, and a bulb 433. Fewer, more, or different components may be provided. The structure and functionality of the connector 425, the power circuitry 429, and the bulb 433 is similar to the connector 324, the power circuitry 328, and the bulb 332, respectively, as previously mentioned.

Alternatively, the compact fluorescent light device 120, 300, and/or 401 may include a processor. The processor is a general processor, application-specific integrated circuit (“ASIC”), digital signal processor, field programmable gate array (“FPGA”), digital circuit, analog circuit, or combinations thereof. The processor is one or more processors operable to control and/or communicate with the various electronics and logic of the compact fluorescent light device 120, 300, and/or 401.

The processor may be configured to read or process data that may be encoded in the low voltage signal provided by the power supply line 108. The processor may read a bit sequence from the power supply signal and perform an action corresponding to the bit sequence. For example, a bit sequence or other data communication encoded in the power signal may command the processor to turn a compact fluorescent light source on or off or to dim or increase a brightness level. The processor turns the compact fluorescent light source on or off or changes a light output level via one or more output signals, such as a pulse width modulated signal, based on the encoded data. For example, processor sends a signal to a switch or other device to constantly or intermittently (for dimming or changing a lighting level) disconnect power from the compact fluorescent light source.

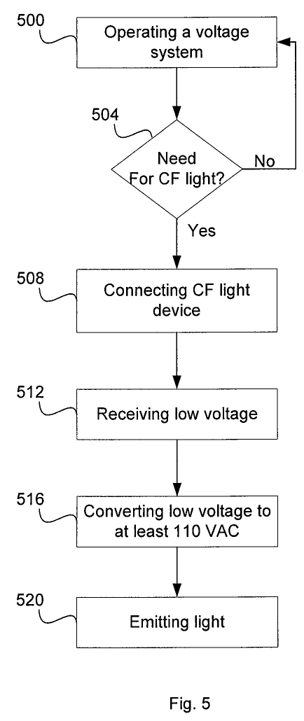

FIG. 5 illustrates a method for providing light. Fewer, more, or different acts or blocks may be provided. A voltage system, such as the system 100, is operated, as in block 500. For example, a user or homeowner turns on or allows for operation of a low voltage system, such as an outdoor lighting system. The system provides a low voltage power signal, such as a 12 VAC, via a power supply line, such as the power supply line 108. The low voltage power signal provides power or operates remote devices, such as the remote devices 112 and 116. For example, the remote devices 112 are outdoor lights, and the remote device 116 is another device powered by a low voltage. The remote devices may be placed in a garden area or may illuminate or operate near a driveway or pathway or other surroundings.

In block 504, a need or desire for a compact fluorescent light is determined. For example, if the user does not want or need to use a compact fluorescent light, then the low voltage system may continue to operate as is or may be turned off. However, if the user does want or need to use a compact fluorescent light, such as for a flood light, then, as in block 508, a compact fluorescent light device, such as the compact fluorescent light device 120, 300, and/or 401, is connected with the low voltage system.

For example, the user may want to operate a flood light for security, aesthetic, or other purposes in a garden area or other outdoor setting. The user connects the compact fluorescent light device to the power supply line 108 via a connector, as previously mentioned. The compact fluorescent light device may be movable or transferable in the outdoor environment to be placed at a desirable location.

The compact fluorescent light device may operate while the outdoor lights or remote devices are on or operating. Alternatively, the outdoor lights or remote devices may be manually turned off while the power supply, such as the power supply 104, is on. Or, the power supply may encode the low voltage signal on the power supply line 108 to command the remotes devices or lights to turn off.

In block 512, the compact fluorescent light device receives the low voltage power signal from the power supply line. The low voltage signal is converted, as in block 516, to a higher AC signal, such as at least 90 VAC RMS or 110 VAC RMS by the compact fluorescent light device, as discussed in regards to FIGS. 2, 3, and 4. For example, the low voltage signal is stepped up to the at least 90 VAC RMS or 110 VAC RMS via a transformer. Alternatively, the low voltage signal is rectified and smoothened into a DC voltage, and the DC voltage is increased to a higher DC voltage and converted to the at least 90 VAC RMS or 110 VAC RMS, such as by an inverter.

In block 520, the compact fluorescent light device emits light. For example, the at least 90 VAC RMS or 110 VAC RMS is provided to a compact fluorescent light source, such as the compact fluorescent light source 201, 308, and/or 409. The compact fluorescent light source uses the applied voltage to emit light with higher efficiency than an incandescent bulb and more light output than an LED. Therefore, a cost effective light device, such as an outdoor flood light, including a conventional compact fluorescent light source may be operated in a convenient manner using the existing low voltage system.

Other features described above may be used for additional or other methods of use. Also, the features, components, and/or structures described above may be organized or identified in one or more methods of manufacture.

The logic, software or instructions for implementing the processes, methods and/or techniques discussed above may be provided on computer-readable a non-volatile memory, such as an EEPROM or Flash memory. The functions, acts or tasks illustrated in the figures or described herein are executed in response to one or more sets of logic or instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like.

It is intended that the foregoing detailed description be regarded as illustrative rather than limiting, and that it be understood that the following claims, including all equivalents, are intended to define the scope of this design.

I claim:

1. A light fixture comprising:
a housing;
a voltage converter within the housing and operable to convert an input voltage from a low voltage line to an output voltage; and
a compact fluorescent light source supported by the housing and in communication with the output voltage, the output voltage being capable of energizing the compact fluorescent light source.

2. The light fixture of claim 1, wherein the compact fluorescent light source comprises a conventional compact fluorescent light bulb.

3. The light fixture of claim 1, wherein the low voltage line corresponds to a low voltage line of a low voltage lighting system.

4. The light fixture of claim 1, wherein the housing is configured to be placed in an outdoor environment.

5. The light fixture of claim 1, wherein the compact fluorescent light source is part of an outdoor floodlight.

6. The light fixture of claim 1, wherein the voltage converter includes a step-up transformer.

7. The light fixture of claim 1, wherein the voltage converter includes an inverter.

8. The light fixture of claim 1, wherein the output voltage corresponds to an AC line voltage of approximately 110 V_{RMS}.

9. The light fixture of claim 1, wherein the output voltage corresponds to an AC line voltage of approximately 220 V_{RMS}.

10. The light fixture of claim 1, wherein the housing includes pivotally connected upper and lower portions, the upper portion being adapted to support the compact fluorescent light and the lower portion being adapted to support the voltage converter and also adapted to be inserted into the ground.

11. The light fixture of claim 1, wherein the housing includes pivotally connected upper and lower portions, the upper portion being adapted to support the compact fluorescent light and the voltage converter and the lower portion is adapted be inserted into the ground.
